(19) United States
(12) Patent Application Publication
(10) Pub. No.: US 2024/0164566 A1
(43) Pub. Date: May 23, 2024

(54) MOTORLESS SOUS VIDE

(71) Applicant: Breville Pty Limited, Alexandria (AU)

(72) Inventors: Stephen John MCCLEAN, Alexandria (AU); Duncan Bruce HELLMERS, Alexandria (AU); Johnson THIE, Alexandria (AU)

(73) Assignee: Breville Pty Limited, Alexandria (AU)

(21) Appl. No.: 18/552,523

(22) PCT Filed: Apr. 4, 2022
(86) PCT No.: PCT/AU2022/050397

§ 371 Date: Sep. 26, 2023

(30) Foreign Application Priority Data
Apr. 30, 2021 (AU) 2021901290

(51) Int. Cl. A47J 27/10; A23L 5/10; H05B 3/26; H05B 3/82

(52) U.S. Cl. CPC A47J 27/10; A23L 5/13; A47J 2202/00; H05B 3/26; H05B 3/82; H05B 2203/013

(57) ABSTRACT

A sous vide device (10) for at least partial immersion in a liquid (16) contained in a vessel (30), the sous vide device (10) comprising:
a housing (12) defining a cavity (14) for fluidic communication with the vessel (30) to at least partially fill the cavity (14) with the liquid; and,
a heater (32) for heating the liquid (16) in the cavity (14) to generate vapour that displaces some of the heated liquid (16) from the cavity (14) into the vessel (30).

### RELATED APPLICATIONS

The present application claims Convention priority from Australian Provisional Patent Application No. 2021901290, the contents of which are incorporated herein in their entirety by reference.

### FIELD

The present invention relates to thermal immersion circulation devices and in particular, but not exclusively, to sous vide appliances.

### BACKGROUND

Thermal immersion circulation devices heat and circulate a liquid in a vessel to a set temperature. Circulation provides an even and consistent liquid temperature throughout the vessel. These devices have application in laboratory and industrial settings but also in domestic kitchens, in particular for sous vide cooking.

Low temperature cooking appliances, such as sous vide appliances, provide for circulation of a liquid (usually water) in which a food product is cooked over a long period of time. Normally, a sous vide appliance has an electrically resistive heater element to heat the water in the vessel while motor-driven components circulate the water about the vessel. Typically, the sous vide appliance has an elongate housing which can be partially or fully immersed in the vessel. Liquid is drawn through the elongate housing by the motor-driven components for heating with the heating element, and then circulated back into the vessel. Sensors and control circuitry control the liquid temperature in the vessel for the duration of the cooking.

Sous vide cooking normally takes a relatively long time. The food product is placed in a polymer bag and immersed in the liquid to cook at a reasonably low temperature (say 55 to 75° C.) for a number of hours. During this time, the sous vide appliance is using a motorised pump or impeller to provide the necessary circulation. The prolonged periods of use make the motor, pump and other moving parts prone to failure.

It is an object of the present invention to overcome or ameliorate at least some of the disadvantages of the prior art, or at least provide a useful alternative.

### SUMMARY OF INVENTION

In one aspect, the invention provides a sous vide device for at least partial immersion in a liquid contained in a vessel, the sous vide device comprising:
a housing defining a cavity for fluidic communication with the vessel to at least partially fill the cavity with the liquid; and,
a heater for heating the liquid in the cavity to generate vapour that displaces some of the heated liquid from the cavity into the vessel.

Preferably, the heater is configured to generate the vapour within the cavity to increase pressure in a head space within the cavity such that the head space expands to displace some of the liquid out of the cavity.

Preferably, the housing has an opening for fluidic communication between the vessel and the cavity. Optionally, the opening is beneath the cavity during use of the sous vide device. Optionally, the opening is positioned on the housing such that during use, the opening is beneath a minimum liquid fill level in the vessel.

Preferably, the heater is a resistive element extending into the cavity interior for at least partial immersion in the liquid within the cavity. Optionally, the heater has a resistive element supported on a wall of the housing. Optionally, the heater has a thick film of electrically resistant material on a surface of the housing in thermal contact with the cavity. Optionally, the heater is a coil. Optionally, the heater is positioned beneath the cavity. For example, the heater may be on a support under the opening to the cavity so vapour bubbles rise to the head space.

Preferably, the housing has a vent for fluid communication between the head space and atmosphere, the vent being positioned at an upper portion of the cavity during use of the sous vide device.

Preferably, the vent has a transverse cross-sectional area between 0.008 mm² to 20 mm². Preferably, the vent has a circular transverse cross section with a diameter between 0.1 mm and 5 mm. Preferably, the diameter is between 1 mm and 2 mm.

Preferably, the housing includes a layer of insulating material to insulate the liquid in the vessel from the heater and the liquid in the cavity.

Preferably, the sous vide device further comprises a first temperature sensor for sensing the temperature of the liquid in the vessel.

In a further preferred form, the sous vide device has a second temperature sensor for sensing the temperature within the cavity.

Preferably, the sous vide device further comprises a pressure transducer for sensing pressure within the liquid in the cavity.

In one form of the invention, the liquid flows into the cavity through the opening and flows out of the cavity through the opening.

In another form, the opening is an inlet allowing the liquid to flow into the cavity and the sous vide further comprises an outlet for liquid flowing out of the cavity.

Preferably, the sous vide device further comprises a foot structure for supporting the housing in an upright orientation on an internal base surface of the vessel. In a further preferred form, the structure is configured such that liquid flow out of the cavity urges the foot structure into abutting engagement with the internal floor surface of the vessel.

Preferably, the housing is generally tubular.

In a further preferred form, the foot structure is provided as an inverted cone.

Preferably, the liquid is water and the vapour generated by the heater is steam.

Preferably, the inlet has an inlet valve and the outlet has an outlet valve, wherein the inlet and outlet valve allow flow of liquid in one direction only.

Preferably, the sous vide device further comprises a processor for feedback control of the temperature of the liquid in the vessel.

In another aspect, the present invention provides a method of cooking a food item in a vessel containing a liquid, the method comprising the steps of
immersing, at least partially, a sous vide device in the liquid contained in the vessel, the sous vide device having a housing which defines a cavity for receiving portion of the liquid contained in the vessel;
inputting a predetermined temperature into the sous vide device, the predetermined temperature being the temperature required for sous vide cooking of a food product immersed in the liquid contained in the vessel;
heating the portion of the liquid in the cavity to generate vapour such that the vapour displaces some of the liquid in the cavity back into the liquid contained in the vessel; and
allowing the vapour to cool and reduce pressure such that liquid contained in the vessel flows to the cavity; and
repeatedly heating and cooling until the liquid contained in the vessel reaches the predetermined temperature.

Sous vide devices and methods described above may provide a range of potential benefits and advantages over conventional sous vide devices, including one or more of
Lower manufacturing costs
Simplified assembly
More energy efficiency
Less risk of compromising food
More easily cleaned
Reduced risk of heat stress on components
Ease of disassembly
Faster heat-up time due to more wattage available for the heater.

### BRIEF DESCRIPTION OF DRAWINGS

Preferred embodiments of the present invention will now be described by way of example only with reference to the accompanying drawings, in which:

FIG. 1 is a perspective view of a first embodiment of the sous vide device with a partially cutaway housing to reveal the heater within the cavity;

FIG. 2 is a vertical cross-section of the first embodiment of the sous vide device shown in FIG. 1;

FIG. 3 is a vertical cross-section of a second embodiment of the sous vide device with the outlet valve open and inlet valve shut;

FIG. 4 is a vertical cross-section of the second embodiment of the sous vide device with the inlet valve open and the outlet valve closed;

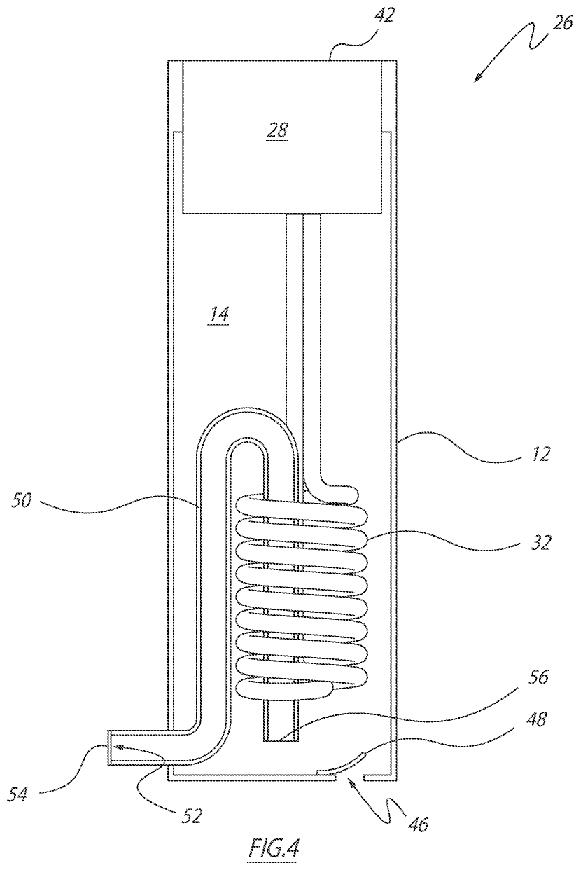

FIG. 5 is a perspective view of the first embodiment shown in FIG. 1 with the addition of a vent for venting the steam to atmosphere;

FIG. 6 is a vertical cross-section of the sous vide device shown in FIG. 5 partially immersed in a vessel containing liquid;

FIG. 7 is a vertical cross-section of the sous vide device shown in FIG. 5 partially immersed in liquid and during the first stage of its operation;

FIG. 8 is a vertical cross-section through the sous vide device of FIG. 5 during the second stage of its operation;

FIG. 9 is a vertical cross-section of the sous vide device shown in FIG. 5 during a third stage of its operation;

FIG. 10 is a flow chart showing the cyclical operation of the sous vide device to cook at food product within a vessel containing liquid;

FIG. 11 is a vertical cross-section through the second embodiment of the sous vide device partially immersed in liquid during a first stage of its operation;

FIG. 12 is a vertical cross-section through the second embodiment of the sous vide device during a second stage of its operation; and

FIG. 13 is a vertical cross-section through the second embodiment of the sous vide device during a third stage of its operation.

### DETAILED DESCRIPTION OF THE PREFERRED EMBODIMENTS

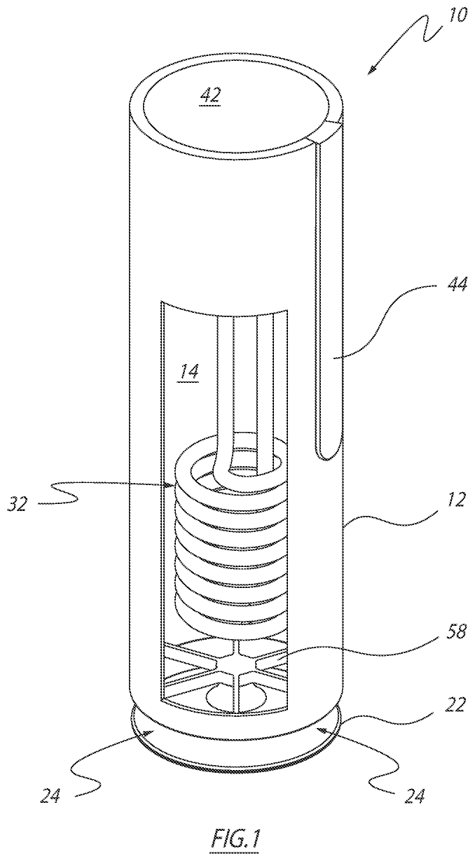

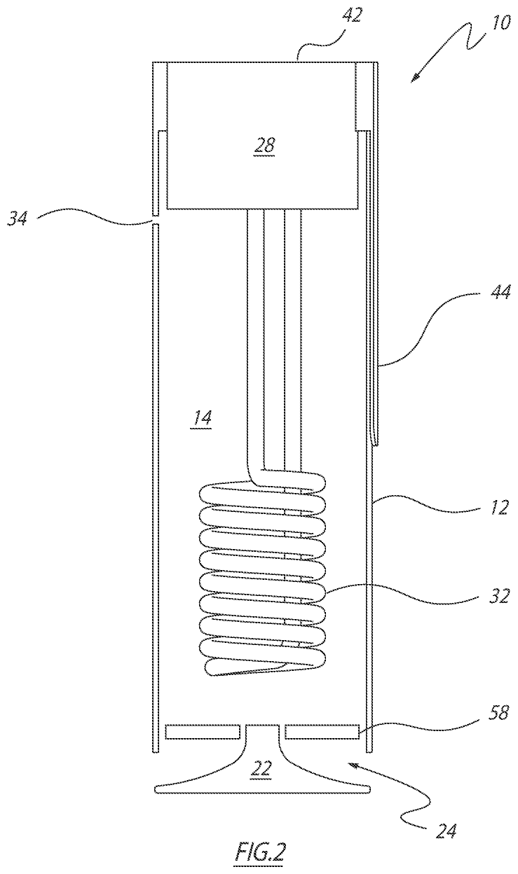

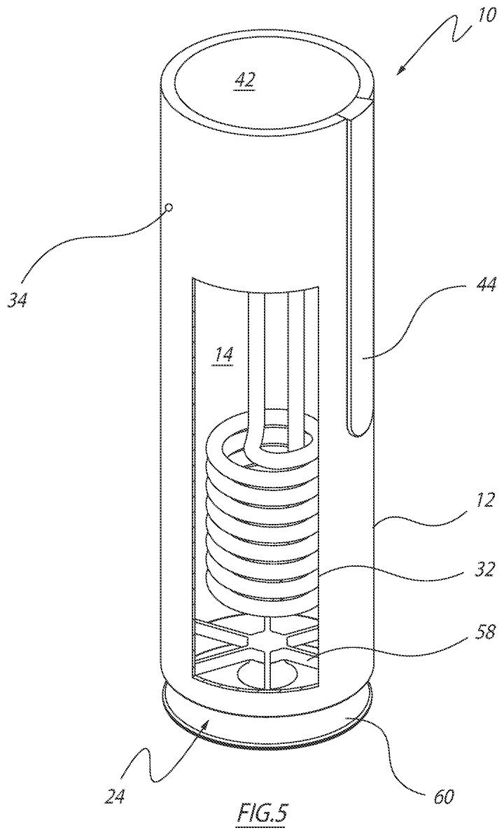

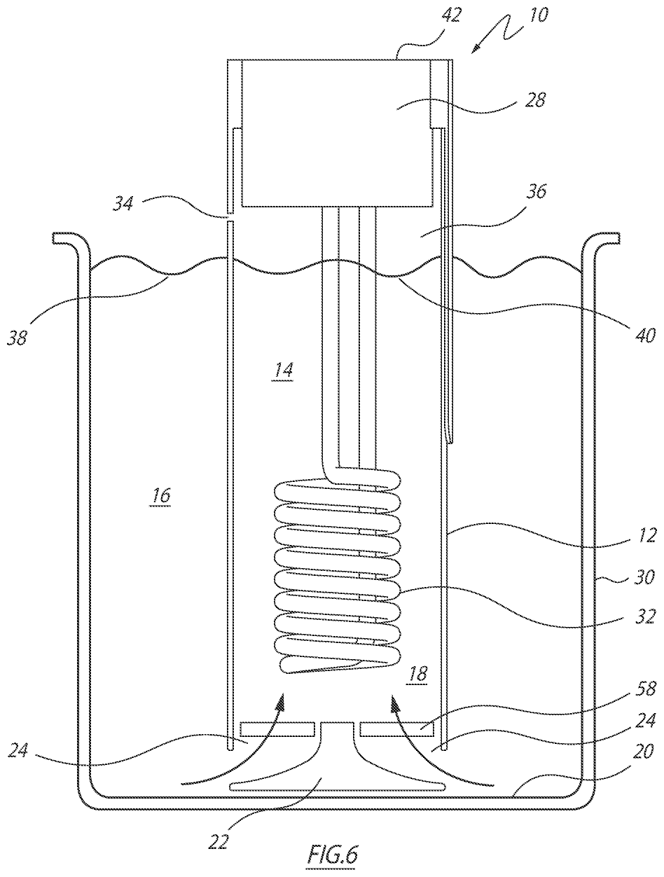

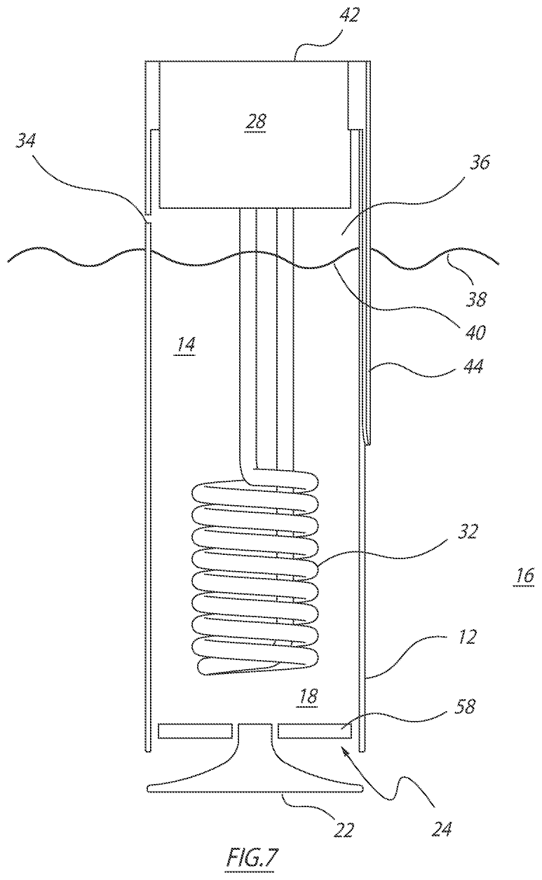

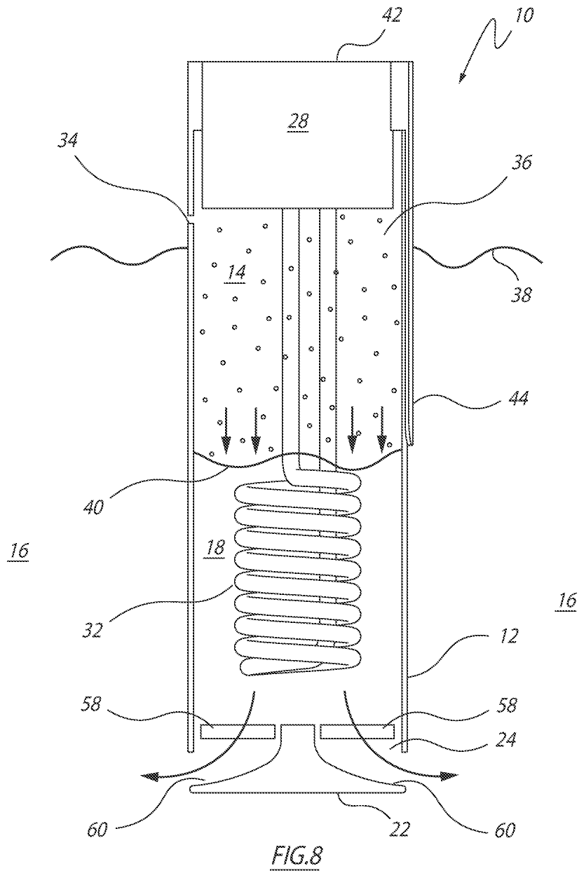

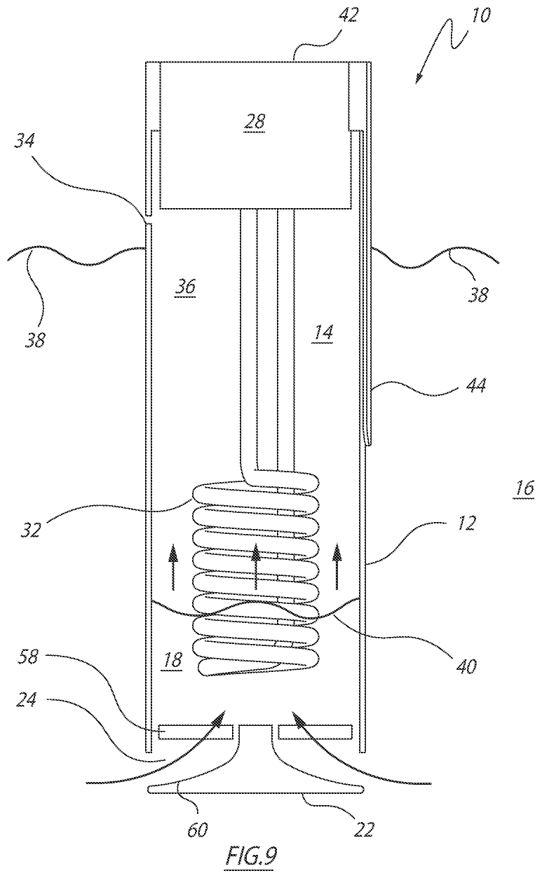

A first embodiment of the sous vide device 10 is shown in FIGS. 1, 2 and 5 to 9. The device has an elongate housing 12 with an internal cavity 14. During use, it is placed in a vessel 30 (see FIG. 6) containing liquid 16, usually water. The device stands on a support foot 22 resting on the base 20 of the vessel 30 and may be fully or partially immersed in the water 16. The elongate housing 12 in the form of a tubular body 26 defining an internal cavity 14 with an opening 24 at its lower end and control electronics 28 within the upper end. Water 16 flows through the opening 24 and fills the cavity 14 until water level 40 within the cavity 14 matches the water level 38 in the vessel 30 (when the device is partially immersed). If fully immersed, the cavity 14 completely fills as the air is forced out the vent 34. Air in the head space 36 of the cavity 14 is expelled through the vent 34. The diameter of the vent 34 is about 0.1 mm to 5 mm and preferably about 1.5 mm (say 1 mm to 2 mm). Dimensioning the vent within this range vents air at a reasonable rate while allowing vapour pressure to build up in the head space 36 when the internal water 18 is heated. However, the vent 34 is not essential in all forms of the sous vide device 10 which can be held horizontally in the water 16 to fill the cavity 14 before being placed upright on the foot 22.

The upper surface of the housing has a user interface 42 for inputting desired temperature for the liquid 16 contained in the vessel 30. The user may also input the cooking time and optionally a delayed start time. The control electronics 28 activates the heater 32 via controlled connection to a power supply (not shown). The Figures show the heater 32 as a coiled resistive element extending from the control electronics 28 at the top of the housing 12 to the lower portion of the cavity 14, proximate the opening 24. However, the heater may also be a thick film heating element applied to the wall of the housing 12.

As the heater 32 heats the water 18 within the cavity 14, vapour (in this case steam) is generated in the head space 36 above the internal water level 40. If the steam is generated at a rate exceeding the flow rate of air and vapour venting to atmosphere, the pressure builds in the head space 36 and pushes the internal water level 40 downwards to displace heated water 18 out of the opening 24 and into the vessel 30. The displaced heated water 18 diffuses into the water 16 in the vessel and raises its temperature. A temperature sensor 44 on a submerged part of the housing 12 monitors the water temperature and the control electronics 28 maintains power to the heater 32 if the current temperature is less than the desired cooking temperature.

Despite the heater 32, the vapour in the head space 36 eventually cools slightly and the pressure reduces. Flow through the vent 34 also reduces pressure in the head space 36 but embodiments of the sous vide without a vent still have small pressure decreases with temperature fluctuations in the head space 36.

The pressure drop allows the internal water level 40 to rise and relatively cool water 16 is drawn into the cavity 14 through the opening 24. This causes the internal water 18 cools the head space 36 further which in turn further reduces the pressure and the internal water level 40 rises. Eventually, the internal water level 40 equalizes (or at least nearly equalizes) with the water level 38 in the vessel 30. This removes the hydrostatic pressure difference feeding cooler water into the cavity 14 by the opening 24 and the process repeats as the heater 32 once again generates vapour to raise the pressure in the head space 36.

This cycle of displacing heated water 18 into the vessel 30 and replacing it with cooler water 16 from the vessel 30, continues until the temperature sensor 44 detects the desired cooking temperature. The control electronics 28 deactivates a heater 32 but continues to monitor the vessel water 16 temperature via the temperature sensor 44. When the vessel water 16 cools by a predetermined margin (and preset cooking time not expired), the control electronics 28 reactivates the heater 32.

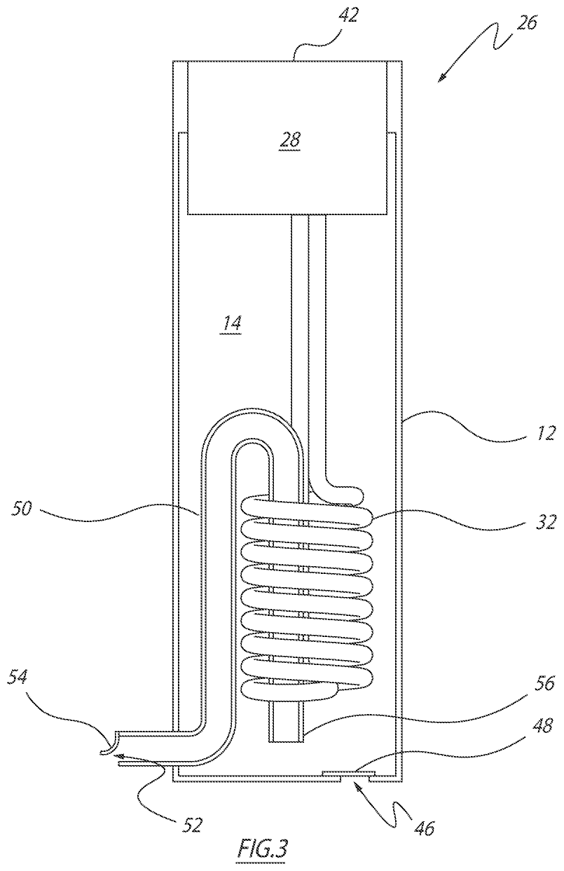

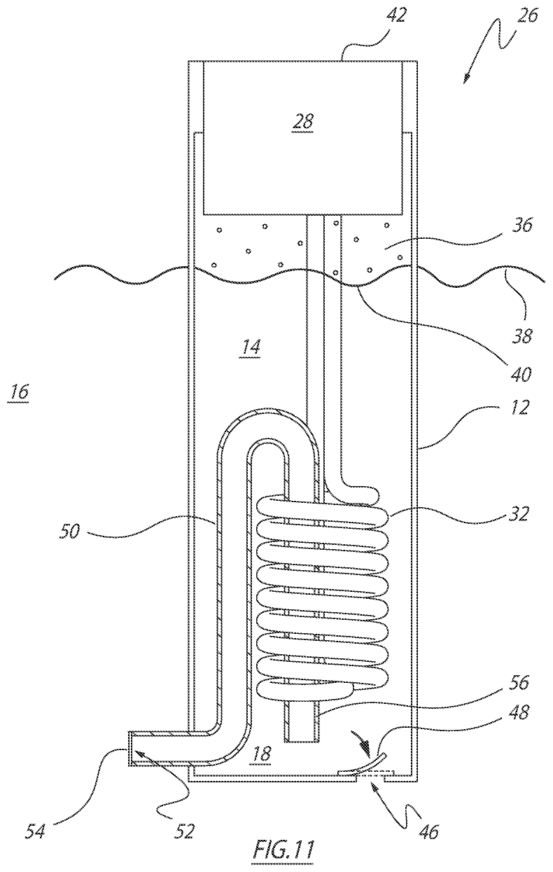

FIGS. 3 and 11 to 13 show a second embodiment of the sous vide device 26. The second embodiment of the sous vide device 26 differs from the first embodiment in that the housing 12 has an inlet 46 and an outlet 52 instead of just an opening providing both an inlet and an outlet. The inlet 46 has a one-way valve 48 that allows vessel water 16 into the cavity 14 within the housing 12. Opening the inlet valve 48 requires the hydrostatic pressure on the internal side of the valve to be less than that on the external side of the inlet 46. Conversely, the inlet valve shuts when the hydrostatic pressure of the internal water 18 is greater than that of the vessel water 16 on the external side of the inlet 46.

The outlet 52 is at a downstream end of an outlet tube 50. The outlet 52 is external to the housing 12 but the majority of the outlet tube 50 is within the cavity 14 with a portion extending through the coils of the heater 32 for better heat conduction to the internal water 18 as it flows from the upstream end to the outlet tube to the downstream end.

The outlet valve 54 at the outlet 52 operates in a similar manner to the inlet valve 48. That is, the outlet valve 54 opens when the hydrostatic pressure of the internal water 18 at the outlet 52 exceeds that of the vessel water 16 on the external side of the outlet 52. Similarly, the outlet valve 54 closes when the hydrostatic pressure in the vessel water 16 exceeds that of the internal water 18 at the outlet 52.

The upstream end 56 of the outlet tube 50 is approximate the bottom of the cavity 14 to reduce the risk of the cavity water level 40 dropping below the upstream end. This would draw steam bubbles into the outlet tube and eject them from the outlet 52 in a manner that may destabilize the sous vide device 26 when first placed in the vessel 30 (see FIG. 6). The sous vide device 26 is partially immersed in the vessel water 16 such that the elongate housing 12 has the user interface 42, control electronics 28 at the upper end while the inlet 46 and outlet 52 are at the lower end where the device rests on the floor of the vessel. Some forms the sous vide device are configured such that it attaches to the side of the vessel such that it is completely or partially immersed thereby avoiding the need for a support foot (see foot 22 shown in FIG. 1).

If the sous vide device has a vent, the internal water 18 fills the cavity 14 until the cavity water level 40 matches the vessel water level 38. If the sous vide device 26 has no vent, the cavity water level 40 may differ from the vessel water level 38 or there may be no head space 36 at all prior to activating the heater 32.

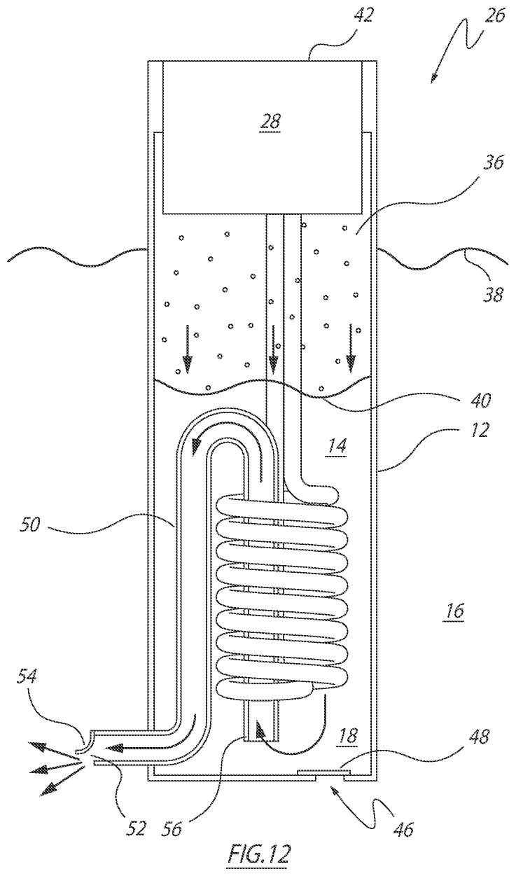

Once the heater 32 is activated by the user via the interface 42, steam is generated and vapour pressure builds in the interface 36. As shown in FIG. 12, this pressure increases the volume of the head space 36 to lower the internal water level 40. The increased pressure in the internal water 18 closes the inlet valve 48 and displaces water to the upstream end 56 of the outlet tube 50 which is expelled through the outlet valve 54 into the vessel water 16. The relatively hot internal water 18 from the cavity 14 mixes with the vessel water 16 to raise the temperature towards the cooking temperature.

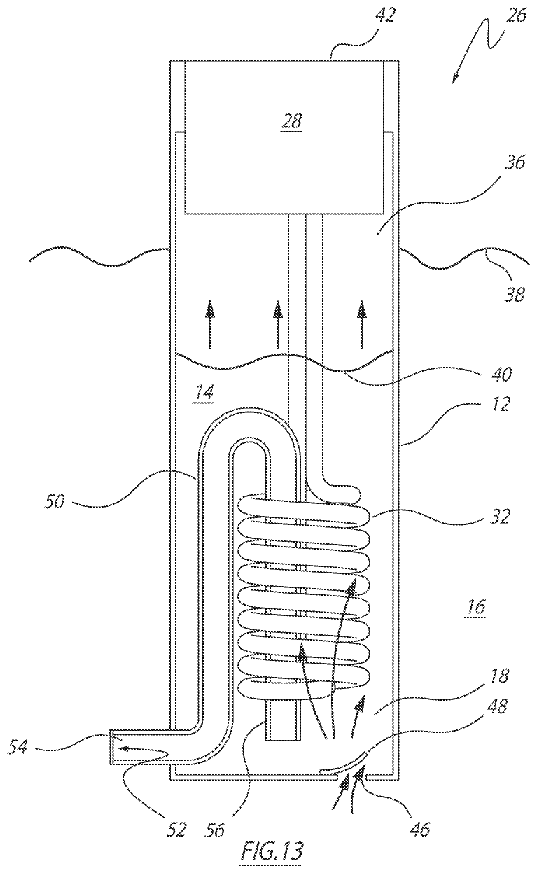

As best shown in FIG. 13, the head space 36 expands to a point where the steam starts to cool which rapidly reduces the pressure and the head space volume also reduces. As the internal water level rises, the outlet valve 54 closes and the reduce internal pressure opens in the valve 48. Relatively cool vessel water 16 flows into the cavity 14 to cool the internal water 18. Cooling the internal water 18 further cools the vapour in the head space 36 to further reduce the head space volume and admit more vessel water 18 into the cavity 14.

The head space continues to reduce until the pressure in the cavity 14 equalizes with that of the vessel water 16. Often, this will involve the cavity water level 40 rising to the same height as the vessel water level 38.

At this stage the inlet valve 48 will close so that the flow of relatively cool vessel water 16 into the cavity 14 stops. As the heater 32 is still active, the internal cavity water 18 starts heating once more to generate steam and build the pressure in the head space 36. This process repeats until the temperature sensor (not shown) detects the vessel water 16 is at the desired cooking temperature. Once the cooking temperature has been reached the control electronics 28 periodically monitor the temperature of the vessel water 16 to reactivate the heater 32 once the temperature drops by a preset margin or predetermined value.

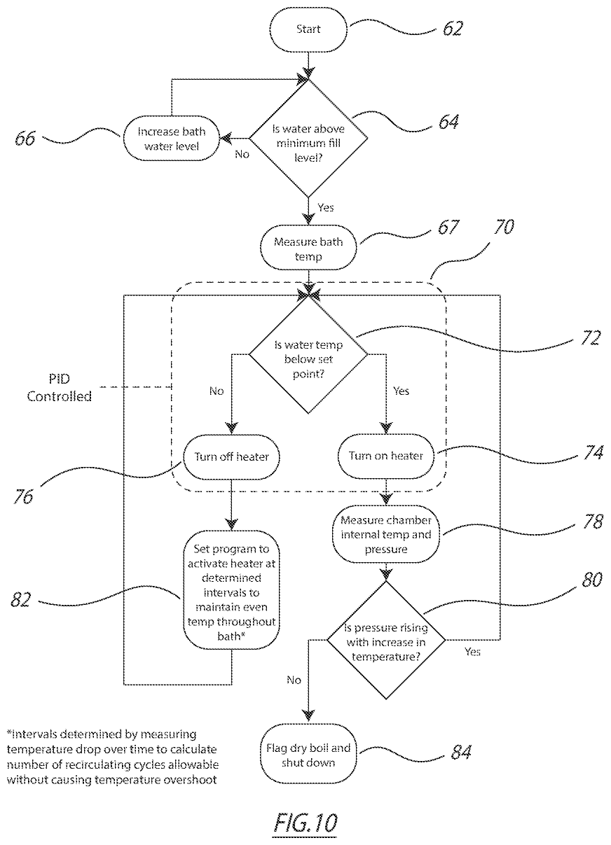

The operation of the sous vide device will now be described with reference to the flow chart shown in FIG. 10. The food to be cooked is placed in a food-grade polymer pouch and sealed shut (preferably vacuumed sealed shut). The food is immersed in a vessel containing liquid, typically water. The sous vide device is then partially or fully immersed in the water contained in the vessel together with the food product. The user sets the desired cooking temperature via the interface on the top surface of the housing as discussed above. The cooking time is also input via the user interface and a delay start if necessary.

The sous vide device is positioned in the vessel such that the elongate housing is generally upright. The housing may have at least one support foot for standing the sous vide device on the bottom of the vessel. However, the device may also hook onto a side wall of the vessel, or be detachably held in an upright position via another method such as magnetic coupling to the vessel and so on.

Water from the vessel partially or fully fills the cavity within the housing. The cavity includes a water level sensor that provides an output to the control electronics once the user has activated the device 62, the controller electronics determine whether the water level in the cavity is above a preset minimum 64. If the water level is beneath the minimum, a notification is displayed on the interface asking the user to increase the water level in the vessel 66.

When the control electronics has determined the cavity water level is above the preset minimum, the sous vide device measures the temperature of the water in the vessel 68.

The detected vessel water temperature and the selected cooking time are used for feedback control 70 of the heater in the cavity. The control electronics periodically detect the temperature of the water in the vessel to determine whether it is above or below the cooking temperature set by the user 72. When the vessel water temperature is below the cooking temperature, the control electronics activates the heater 74.

The heater begins the cyclic process of heating the water in the cavity to generate steam and expand the head space to displace relatively hot water into the vessel. Discussed in detail above, the head space then cools and contracts to draw the vessel water into the cavity for heating.

Eventually the control electronics detects that the vessel water is above the cooking temperature 72 and the user selected cooking time not expired, the control electronics. The control electronics activate the heater at intervals to maintain the uniform temperature throughout the water in the vessel. The intervals are determined by the control electronics by measuring flash detecting temperature drop over time and calculating the number of recirculation needed to restore the temperature to the cooking temperature without overshooting.

The invention has been described here by way of example only. Skilled workers in this field of technology will readily recognize may variations and modifications which do not depart from the spirit and scope of the broad inventive concept.

1. A sous vide device for at least partial immersion in a liquid contained in a vessel, the sous vide device comprising:
a housing defining a cavity for fluidic communication with the vessel to at least partially fill the cavity with the liquid; and,
a heater for heating the liquid in the cavity to generate vapour that displaces some of the heated liquid from the cavity into the vessel.

2. The sous vide device according to claim 1, wherein the heater is configured to generate the vapour within the cavity to increase pressure in a head space within the cavity such that the head space expands to displace some of the liquid out of the cavity.

3. The sous vide device according to claim 2, wherein the housing has an opening for fluid communication between the vessel and the cavity.

4. The sous vide device according to claim 3, wherein the opening is beneath the cavity during use of the sous vide device.

5. The sous vide device according to claim 3 or 4, wherein the opening is positioned on the housing such that during use, the opening is beneath a minimum liquid fill level in the vessel.

6. The sous vide device according to any one of claims 3 to 5, wherein the heater is a resistive element extending into the cavity interior for at least partial immersion in the liquid within the cavity.

7. The sous vide device according to any one of claims 3 to 6, wherein the heater has a resistive element supported on a wall of the housing.

8. The sous vide device according to claim 7 wherein the heater has a thick film of electrically resistant material on a surface of the housing in thermal contact with the cavity.

9. The sous vide device according to any one of claims 3 to 8, wherein the heater is positioned beneath the cavity.

10. The sous vide device according to any one of claims 1 to 9, wherein the housing has a vent for fluid communication between the head space and atmosphere, the vent being positioned at an upper portion of the cavity during use of the sous vide device.

11. The sous vide device according to claim 10, wherein the vent has a transverse cross-sectional area between 0.008 mm² to 20 mm².

12. The sous vide device according to claim 10 or 11 wherein the vent has a circular transverse cross section with a diameter between 0.1 mm and 5 mm.

13. The sous vide device according to claim 12 wherein the diameter is between 1 mm and 2 mm.

14. The sous vide device according to any one of claims 1 to 13, wherein the housing includes a layer of insulating material to insulate the liquid in the vessel from the heater and the liquid in the cavity.

15. The sous vide device according to any one of claims 1 to 14, further comprising a first temperature sensor for sensing the temperature of the liquid in the vessel.

16. The sous vide device according to claim 15 further comprising a second temperature sensor for sensing the temperature within the cavity.

17. The sous vide device according to claim 15 or claim 16, further comprising a pressure transducer for sensing pressure within the liquid in the cavity.

18. The sous vide device according to any one of claims 1 to 17 wherein during use the liquid flows into the cavity through the opening and flows out of the cavity through the opening.

19. The sous vide device according to any one of claims 1 to 17 wherein the opening is an inlet allowing the liquid to flow into the cavity and the sous vide device further comprises an outlet for liquid flowing out of the cavity.

20. A sous vide device according to claim 19, wherein the inlet has an inlet valve and the outlet has an outlet valve, wherein the inlet and outlet valve allow flow of liquid in one direction only.

21. The sous vide device according to any one of claims 1 to 20, further comprising a foot structure for supporting the housing in an upright orientation on an internal base surface of the vessel.

22. The sous vide device according to claim 21, wherein the foot structure is configured such that liquid flow out of the cavity urges the foot structure into abutting engagement with the internal floor surface of the vessel.

23. The sous vide device according to claim 21 or 22, wherein the foot structure is provided as an inverted cone.

24. The sous vide device according to any one of claims 1 to 23, wherein the housing is generally tubular.

25. The sous vide device according to any one of claims 1 to 24, wherein the liquid is water and the vapour generated by the heater is steam.

26. A sous vide device according to any one of claims 1 to 25, further comprising a processor for feedback control of the temperature of the liquid in the vessel.

27. A method of cooking a food item in a vessel containing a liquid, the method comprising the steps of:
at least partially immersing a sous vide device in the liquid contained in the vessel, the sous vide device having a housing which defines a cavity for receiving portion of the liquid contained in the vessel;
inputting a predetermined temperature into the sous vide device, the predetermined temperature being the temperature required for sous vide cooking of a food product immersed in the liquid contained in the vessel;
heating the portion of the liquid in the cavity to generate vapour such that the vapour displaces some of the liquid in the cavity back into the liquid contained in the vessel;
allowing the vapour to cool and reduce pressure such that liquid contained in the vessel flows to the cavity; and
repeatedly heating and cooling until the liquid contained in the vessel reaches the predetermined temperature.
